(19) United States
(12) Patent Application Publication
(10) Pub. No.: US 2024/0343221 A1
(43) Pub. Date: Oct. 17, 2024

(54) IDENTIFICATION OF UNAUTHORIZED OCCUPANTS USING TRUST RELATION PAIR IDENTIFICATION

(71) Applicant: Volvo Car Corporation, Göteborg (SE)

(72) Inventors: Gerardo Morales, Gothenburg (SE); Oswaldo Perez Barrera, Gothenburg (SE)

(21) Appl. No.: 18/299,280

(22) Filed: Apr. 12, 2023

(51) Int. Cl. B60R 25/24; B60R 25/10; B60R 25/25; B60R 25/30

(52) U.S. Cl. CPC B60R 25/24; B60R 25/10; B60R 25/25; B60R 25/305; B60R 2025/1013; B60R 2325/205

(57) ABSTRACT

Various systems and methods are presented to control access of a vehicle, wherein access of the vehicle by a first user requires approval by a second user. In the event of access is denied, but the first user operates the first vehicle, the first vehicle can be configured to generate an alarm signal. A second vehicle can be configured to detect the alarm signal and capture digital images of the first vehicle. The digital images can be reviewed to determine at least one of a location, a route, or an operator of the first vehicle. In the event of access to the first vehicle is subsequently granted, transmission of the alarm signal can be terminated, thereby ceasing further generation of images of the first vehicle (e.g., by the second vehicle). The first vehicle and the second vehicle can be operating in any of an autonomous, partially autonomous, or non-autonomous manner.

### TECHNICAL FIELD

This application relates to techniques facilitating prevention of unauthorized use of a vehicle.

### BACKGROUND

Vehicle theft and unauthorized use has been an issue of concern for as long as vehicles have been on roads across the globe. Numerous systems and devices exist to deter and/or prevent theft of a vehicle, however, high levels of car theft continue to be experienced. Theft of a non-autonomous, conventional vehicle typically entails breaking and entering the vehicle, hot-wiring the vehicle, and suchlike. As access to vehicles using digital technologies continues to replace the conventional physical key, users can access a vehicle via electronic key fobs, smart devices, and suchlike, rather than having the physical key in their possession. However, access by such digital technologies presents its own concerns regarding authentication and authorization of potential users of a vehicle, particularly when a vehicle is being operated in an autonomous manner with no driver physically present to allow or deny a person access to the vehicle. An example of digital technologies being subverted to enable theft of a vehicle is replication of an electronic key fob configured to transmit a particular signal to operate a door lock, start engine, etc., of a vehicle. Counterfeiting systems exist that can replicate the signal such that the vehicle can be accessed and stolen even though the car thief does not have the actual key fob required to open the specific vehicle in their possession.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to authorize access and/or control of a vehicle.

According to one or more embodiments, a system can be located on a user device, wherein the user device can comprise a memory that stores computer executable components and a processor that executes the computer executable components stored in the memory. The computer executable components can comprise a pairing component configured to receive an authentication request from a first vehicle, wherein the authentication request includes information regarding a first user, wherein the first user wants to operate the first vehicle. In another embodiment, the authentication request can be presented at the user device. In a further embodiment, the pairing component can further receive a first input, wherein the first input indicates whether the authentication request has been granted or denied.

In another embodiment, the pairing component can be further configured to, in the event of the first input indicates the authentication request has been denied, generate a first notification indicating the authentication request is denied, and further transmit the first notification to the first vehicle. In a further embodiment, the pairing component can be configured to, in the event of the first input indicates the authentication request has been approved, generate a second notification indicating the authentication request is approved, and transmit the second notification to the first vehicle.

In a further embodiment, the computer executable components can further include an image component configured to: receive one or more digital images, wherein the digital images can include at least one of a depiction of the first vehicle or depiction of an occupant of the first vehicle. In an embodiment, the one or more images can be received from a second vehicle, wherein the second vehicle captured the one or more images in response to an alarm signal generated by the first vehicle, wherein generation of the alarm signal can be based at least in part on the second notification being received at the first vehicle.

In another embodiment, the pairing component can be further configured to: receive a second input, wherein the second input indicates recognition of the user; and in response to receiving the second input, further generate a third notification, wherein the third notification indicates the occupant of the first vehicle and the first user are the same and the authentication request is granted.

In a further embodiment, the imaging component can be further configured to receive a last seen location notification, wherein the last seen location notification indicates a most recent position identified for the first vehicle.

In an embodiment, the first device can be a smart device comprising a cellphone, a smartwatch, or a tablet computer.

In another embodiment, the first user information can include at least one of a name, an address, a photograph of the first user, or a unique identifier of the first user.

In a further embodiment, the computer executable components can further include a time component configured to configure a duration of time for which the first input is to be received at the authentication request is presented on the first device, and further, in the event of the first input is not received within the duration of time, the first input can no longer be received at the first device.

In a further embodiment, the pairing component can be further configured to receive a notification of a heart rate of the user, wherein the heart rate is indicated to be above a threshold value or below the threshold value.

In other embodiments, elements described in connection with the disclosed systems can be embodied in different forms such as computer-implemented methods, computer program products, or other forms. For example, in an embodiment, a computer-implemented method can be performed by a user device operatively coupled to a processor. In an embodiment, the method can comprise transmitting, by a first device comprising a processor, an authentication request denial to a first vehicle, wherein the authentication request denial denies use of the first vehicle by a first user. In an embodiment, the computer-implemented method can further comprise receiving, at the first device, a digital image of the first vehicle, wherein the digital image is generated by an imaging system located onboard a second vehicle, wherein the first vehicle is being operated in contravention of the authentication request denial. In another embodiment, the computer-implemented method can further comprise presenting the digital image on the first device, wherein the digital image further comprises metadata indicating at least one of a GPS location of where the digital image was taken, a time when the digital image was generated, a vehicle occupant, or an identifier of the first vehicle.

In another embodiment, the computer-implemented method can further comprise determining a location of the first vehicle based on at least one of the digital image GPS location or the time when the digital image was generated. In an embodiment, the authentication request can include information regarding the first user. In another embodiment, the computer-implemented method can further comprise presenting the first user information on the user device, and further, receiving an input at the user device, wherein the input can be from a second user indicating the authentication request from the first user was accepted or denied based at least in part on the first user information, wherein the user device can be a smart device, a cellphone, a smart watch, or a tablet computer. In a further embodiment, the first user information further comprises an indication of whether the first user was in a state of stress when the authentication request was generated, wherein the stress indication is based on a heart rate of the first user when the authentication request was generated.

Further embodiments can include a computer program product comprising a computer readable storage medium having program instructions embodied therewith, the program instructions executable by a processor, located on a user device, can cause the processor to transmit, from the user device, an authentication request denial to a first vehicle, wherein the authentication request denial denies use of the first vehicle by a first user. In another embodiment, the program instructions can further cause the processor to receive, at the user device, a digital image of the first vehicle, wherein the digital image is generated by an imaging system located onboard a second vehicle, wherein the first vehicle is being operated in contravention of the authentication request denial. In another embodiment, the program instructions can further cause the processor to present the digital image on the user device, wherein the digital image can further comprise metadata indicating at least one of a GPS location of where the digital image was taken, a time when the digital image was generated, a vehicle occupant, or an identifier of the first vehicle. In another embodiment, the program instructions can further cause the processor to determine a location of the first vehicle based on at least one of the digital image GPS location or the time when the digital image was generated. In an embodiment, the authentication request can include information regarding the first user.

In another embodiment, the program instructions can further cause the processor to present the first user information on the user device; and further, receive an input at the first device, wherein the input can be from a second user indicating the authentication request from the first user was accepted or denied based at least in part on the first user information, wherein the user device can be a smart device, a cellphone, a smart watch, or a tablet computer. In a further embodiment, the first user information can further comprise an indication of whether the first user was in a state of stress when the authentication request was generated, wherein the stress indication can be based on a heart rate of the first user when the authentication request was generated.

An advantage of the one or more systems, computer-implemented methods, and/or computer program products can be utilizing various systems/components and technologies located on a user device to control access of a vehicle, and further, in the event of the vehicle being stolen, and suchlike, track and identify location of the vehicle based on digital images taken of the vehicle by other vehicles driving by the vehicle.

### DESCRIPTION OF THE DRAWINGS

One or more embodiments are described below in the Detailed Description section with reference to the following drawings.

FIG. 1 illustrates a system that can be utilized to prevent and/or deter unauthorized operation and/or theft of a vehicle, in accordance with one or more embodiments.

FIG. 2 is a system presenting various components that can be utilized to authorize a user and prevent vehicle theft, in accordance with an embodiment.

FIG. 3 is a schematic illustrating a user device which can be utilized to grant/deny an authentication request, in accordance with an embodiment.

FIG. 4 is an example image that can be captured and analyzed, in accordance with one or more embodiments.

FIG. 5 is a schematic illustrating a vehicle being located by one or more other vehicles, in accordance with an embodiment.

FIG. 6 illustrates a flow diagram for a computer-implemented methodology to grant or deny access to a vehicle, in accordance with at least one embodiment.

FIG. 7 illustrates a flow diagram for a computer-implemented methodology to capture and record operation of a vehicle, in accordance with at least one embodiment.

FIG. 8, illustrates a flow diagram for a computer-implemented methodology to capture and record operation of a vehicle, in accordance with at least one embodiment.

FIG. 9 is a block diagram illustrating an example computing environment in which the various embodiments described herein can be implemented.

FIG. 10 is a block diagram illustrating an example computing environment with which the disclosed subject matter can interact, in accordance with an embodiment.

FIG. 11 presents TABLE 1100 presenting a summary of SAE J3016 detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to utilizing one or more components located on a first vehicle to determine whether an entity should be granted access to the first vehicle, wherein the entity can be a person, user, customer, occupant, etc. Access can be granted or denied based on whether the person requesting access to and/or operation of the first vehicle is, in a non-limiting list: (a) a person having been previously granted access to the first vehicle (e.g., the person is an authorized user), (b) the person is known to an authorized user of the first vehicle, wherein the authorized user (e.g., a primary user, a trusted user) has been tasked with approving use of the vehicle by a non-authorized user, (c) the user is not known to an authorized user, wherein access is denied to this user as no trust has been established between the authorized user and the unknown user.

In an example scenario, the unknown user can be a car thief or suchlike. In another example scenario, a previously-authorized user may be requesting re-access and operation of the first vehicle, but the user is requesting access under duress as they are part of a car theft/car-jacking situation. Accordingly, technology can be utilized to determine the current state of the user, such as their physical condition and/or state. For example, a current heart rate of the user can be determined. During a normal scenario of request, the heart rate of the user is likely at a low stress condition. However, during a car-jacking, the heart rate of the user is likely to be elevated owing to the stressful nature of being involved in a theft.

In the event that (a) an authorized user (e.g., a primary user, a trusted user) has not authorized the person requesting access or (b) the physical condition of a person requesting access indicates a stressed condition, the first vehicle can be configured to transmit an alarm signal. The alarm signal can be configured to be received by other vehicles operating proximate/in the region of operation of the first vehicle. In an embodiment, a second vehicle, upon receiving the alarm signal, can be configured to capture digital imagery of the first vehicle in conjunction with a timestamp and global positioning system (GPS) data identifying the location of the first vehicle when the digital imagery was captured. In the event that the digital imagery contains imagery of the one or more occupants of the second vehicle, the digital imagery can be reviewed to identify the one or more occupants. The second vehicle can transmit the digital imagery to a user device of an authorized user (e.g., the primary user) as well as to a remote, external system/server (e.g., for image analysis, image storage), a law enforcement system, an insurance company system, and suchlike. In an embodiment, the authorized user can review the digital images to determine whether they know the occupant(s), and if so, can subsequently grant them authorization to use the first vehicle, whereupon, transmission of the alarm signal can be ceased. Alternatively, in the event of not recognizing the occupant(s) and/or not wanting the occupant to be operating the first vehicle, the first vehicle can continue to be considered to be operating in an unauthorized manner, whereby, any vehicles that operate in the vicinity of the first vehicle can continue to take digital images of the first vehicle and also report on a location of the first vehicle. Analysis of the digital images and GPS data enables a determination of route of travel of the vehicle and possibly a current location of the vehicle.

In an embodiment, any of the vehicles presented herein (e.g., first vehicle, second vehicle) can be operating in any of a non-autonomous, partially autonomous, or fully autonomous manner.

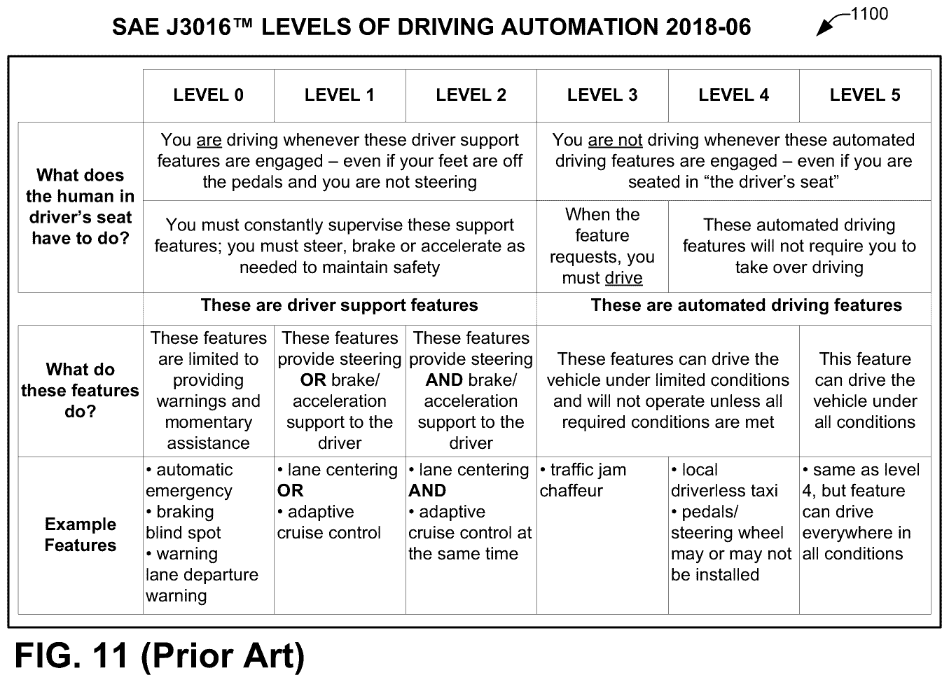

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 11, Table 1100.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically does not drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicles 140, 160A-n) operating in an autonomous manner (e.g., as an AV), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle (e.g., vehicle 160), another vehicle that passes the first vehicle, can also be operating in any of an autonomous manner, a partially autonomous manner, or in a non-autonomous manner.

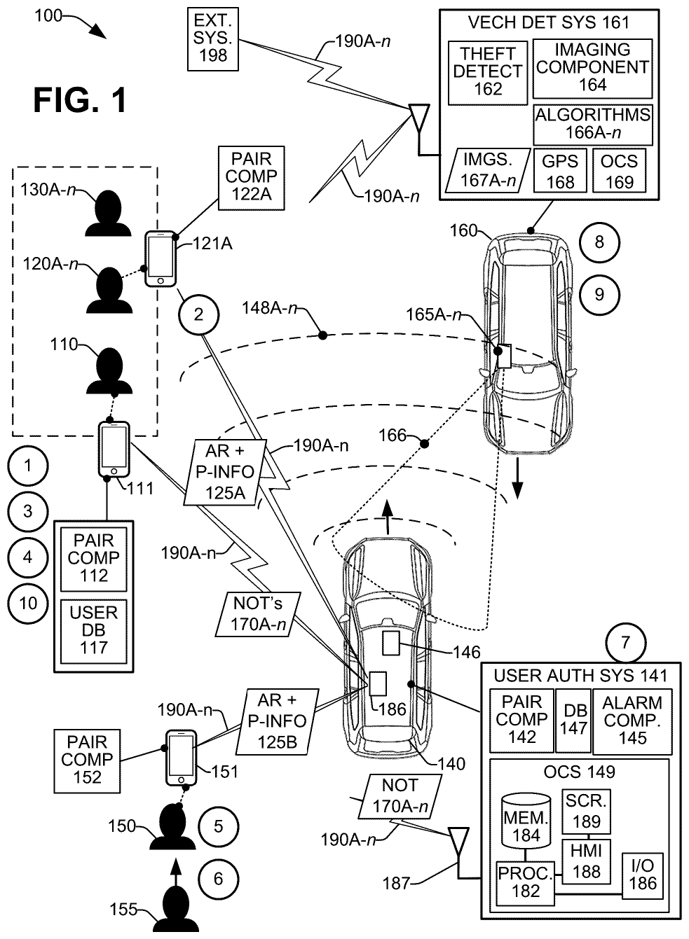

Turning now to the drawings, FIG. 1 illustrates a system 100 that can be utilized to prevent and/or deter unauthorized operation and/or theft of a vehicle, in accordance with one or more embodiments. To enable understanding of the various components and a possible sequence of activities utilized in the various embodiments presented herein, the various systems, components, operations, and suchlike, are presented in a step-thru like manner. The terms “authorization” and “authentication” are used interchangeably herein and relate equally to a user being granted or denied access to a vehicle.

At (1), a collection of one or more users who have been authorized to operate vehicle 140 are presented, wherein each user can communicate with other users, systems, etc., for example, via a user device (e.g., a cellphone, a smartwatch, a portable computer, a tablet computer, and suchlike). The entities can include a primary user 110, one or more trusted users 120A-n, and one or more authenticated users 130A-n. A primary user 110 controls authentication of users requesting access to vehicle 140, trusted users 120A-n can assist a primary user 110 in controlling authentication to/access of vehicle 140 (e.g., where primary user 110 does not respond to an authentication request 125A-n within a specified duration, for example, within 5-10 minutes of the generation of the authentication request), and authenticated users 130A-n who are other users that have been authenticated by primary user 110 and/or trusted users 120A. Communications between the various users (e.g., any of users 110, 120A-n, 130A-n), their respective user devices (e.g., 111, 121A-n, 131A-n), and the various systems (e.g., systems UAS 141 and VDS 161) presented in FIG. 1 can be via signals 190A-n, wherein signals 190A-n can utilize any applicable communication technology.

In the example scenario presented, primary user 110 is using user device 111 to communicate with other users and devices/systems in system 100. Primary user 110 controls who may be authorized to user vehicle 140, wherein authorization can be a trust-based system, such that use of vehicle 140 is typically only available when an authentication request generated by a user has been authenticated by the primary user 110. In an embodiment, authentication can involve a person requesting access to vehicle 140 based on communication utilizing a user device located proximate to the vehicle 140.

During an initial implementation of system 100, the primary user 110 can utilize user device 111 to establish authentication with vehicle 140. During the authentication a pairing component 112 on user device 111 establishes communication (e.g., tethers, pairs, communicatively coupled, and suchlike) with a pairing component 142 on vehicle 140, wherein the pairing component 142 can be included in a user authentication system (UAS) 141 onboard vehicle 140. The authentication process can utilize any suitable technology to establish communications, in an example, primary user 110 is local to vehicle 140 and pairing is performed using BLUETOOTH piconet technology. During the pairing operation, primary user 110 can share personal information with the pairing component 142, e.g., name, cellphone number, etc., wherein the personal information can be stored in a user database 147 local to the pairing component 142 to enable subsequent communications to be performed (e.g., forwarding authentication requests to and/or receiving access grant/denial notifications from the primary user 110). As new users are authorized, the user database 147 can be updated accordingly (e.g., with user personal information and heart rate information as further described herein). At the conclusion of step (1), a pairing/trust relationship is established between primary user 110 and the vehicle 140.

At (2), various other entities requiring access to vehicle 140 can request authentication, wherein a hierarchy of trusted users and authenticated users is generated. For example, once the primary user 110 is established, a first trusted user 120A can be authenticated. In an embodiment, user 120A establishes a communication pairing with the pairing component 142 via their user device 121A and a pairing component 122A operating thereon. Trusted user 120A can interact with user device 121A, such that user device 121A generates and transmits an authentication request 125A to the pairing component 142. The authentication request 125A can include user 120A's personal identity information to enable primary user 110 to identify user 120A and subsequently grant or deny the authentication request 125A. The personal information can include, for example, the name of the user 120A requesting access, cellphone number, physical address, email address, an identification photograph, any suitable number, identifier, and the like, that can uniquely identify the user 120A such as all or a portion of their Social Security number (USA), National Insurance number (UK), Tax File Number (Australia), Personal Identity Number (Sweden), UIDAI Unique Identification Number (India), and suchlike. User database 147 can be updated with user 120A's personal information. As part of the authentication process, as user device 121A initially pairs with the pairing component 142, a copy of user 120A's authentication request 125A and personal information can be forwarded to the primary user 110, wherein user 120A's personal information can be subsequently added to the user database 117 on user device 111. Primary user 110 can utilize (e.g., via user device 111) user 120A's personal identity information included in authentication request 125A, or suchlike, to identify user 120A and subsequently grant or deny the authentication request 125A.

At (3), the pairing component 112 can be further configured to receive and process the authentication request 125A and further, device 111 can be configured to present (e.g., on a HMI/screen on user device 111) the personal details of user 120A for review by the primary user 110. The primary user 110 can review the personal details, and can either grant user 120A access to vehicle 140 or deny access to vehicle 140. To assist primary user 110 in reviewing the authentication request 125A, pairing component 112 can access the user database 117 and present information (if present) regarding user 120A from the list of all the various users that are currently authorized access (e.g., trusted users 120A-n, authorized users 130A-n), have been previously authorized, and anyone that may have been previously denied access.

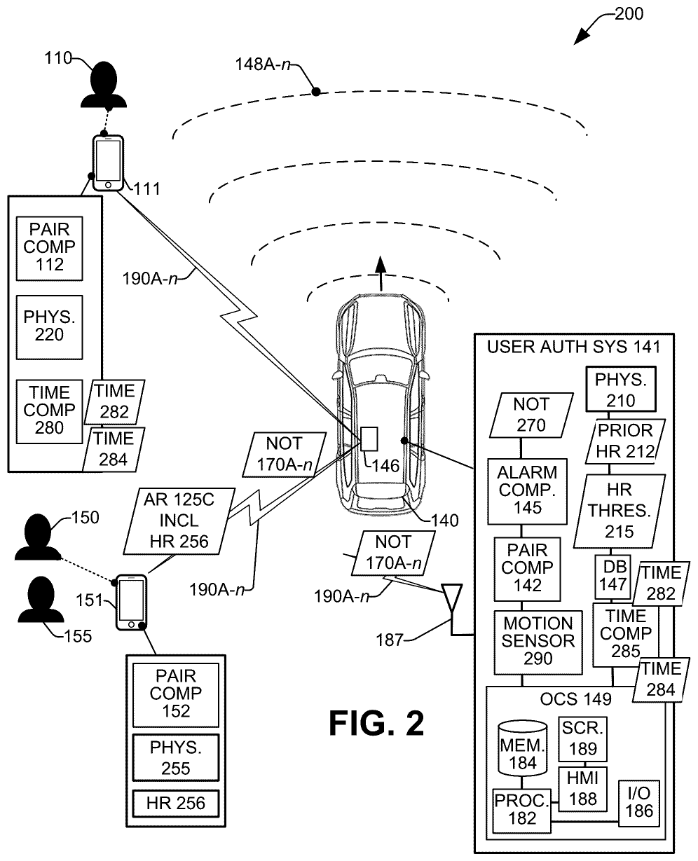

At (4), in response to input from primary user 110 (e.g., via the HMI/screen) a granted/denied access notification 170A can be generated by pairing component 112 and transmitted to pairing component 142 at vehicle 140. The access granted/denied notification 170A can be transmitted to user 120A via vehicle 140 (e.g., via pairing component 142) or directly between user device 111 and user device 121A. In the event of access being granted, user 120A can access and operate vehicle 140. However, as further described below, per FIG. 2, a heart rate monitoring process can be utilized to determine whether the user 120A is being coerced into requesting access by a car thief, for example. In an embodiment, user 120A can be authorized with the intent that user 120A becomes a trusted user 120A, wherein, in the event of the primary user 110 is not available to grant/deny an authentication request, authentication request can be forwarded to the trusted user 120A who can assist with granting or denying access to vehicle 140. At this stage, both primary user 110 and trusted user 120A are paired with and authenticated to access and operate vehicle 140.

At (5), a user 150 can submit an authentication request 125B to access/operate vehicle 140, via pairing component 152 operating on user device 151. At this moment in time, user 150 may be completely unknown to primary user 110, user 150 may be a previously authorized user 130A-n requesting re-access to vehicle 140 (e.g., their heart rate information is already known, ref. FIG. 2, personal information is present in databases 117 and 147), and suchlike. In an example scenario, user 150 may be being coerced into requesting access of vehicle 140 by a person 155 who intends to steal vehicle 140. Similar to the preceding steps (2)-(4), as part of the authentication/access request by user 150, during the initial authorization pairing between pairing component 152 and pairing component 142, an authentication request 125B including the personal information of user 150 is generated by pairing component 152 and transmitted to pairing component 142. The authentication request 125B, including the personal information of user 150, can be subsequently transmitted by pairing component 142 to the pairing component 112 at user device 111. User databases 117 and 147 can be updated with the user 150's personal information.

In an embodiment where the requesting situation of user 150 appears to be normal, e.g., user 150 is known to the primary user 110 and there are no suspicious circumstances behind the authentication request 125B, the primary user 110 (or a trusted user 120A-n) can generate and send an authentication approved notification 170B to user 150 and user 150 is added to the collection of authenticated users 130A-n in databases 117 and 147. In an embodiment, where user 150 is a returning authenticated user, note can be made in databases 117 and 147 of their latest granted authentication.

However, as previously mentioned, it may be possible that user 150 is being forced to request access of vehicle 140 by a car thief 155 or person having malicious intent. Further, a scenario can occur where vehicle 140 has been stolen by person 155.

At (6), in the event of user 150 being involved in a car theft, both directly or indirectly, a notification 170C can be generated by pairing component 142 and transmitted to pairing component 112 indicating that there may be an issue with the authentication request 125B. In an embodiment, primary user 110 can respond with a notification 170D indicating authentication denied. In the event of user 150 was making an honest, uncoerced request to access vehicle 140, user 150 can accept the request denial and if needed, for example, attempt to contact primary user 110 directly to obtain access.

Alternatively, in the event of primary user 110 determines the authentication request 125B is improper, e.g., being made under duress, vehicle 140 is in process of being stolen, etc., primary user 110 can generate a notification 170E, via pairing component 112 on user device 111, wherein notification 170E functions as an instruction for vehicle 140 to operate in an alarmed state.

At (7), an alarm component 145 at vehicle 140 can receive the alarm state notification 170E, and in response thereto, can be configured to generate alarm signals 148A-n (e.g., via an alarm transmitter 146). In an embodiment, while the alarm signals 148A-n can be an audible alarm (e.g., from a speaker/car horn onboard vehicle 140), or a visual alarm (e.g., headlights, hazard lights, etc., onboard vehicle 140), alarm signals 148A-n can also be radio frequency signals emitted from vehicle 140 and configured to be received by other vehicles operating in the vicinity of vehicle 140. In another embodiment, in the event of a notification 170F is transmitted from user device 111 to vehicle 140 and indicates that primary user 110 has denied the authentication request 125B, and yet the vehicle is being operated, e.g., due to car theft or other contravention of the denied authentication request 125, the alarm component 145 can be further configured to generate the alarm signals 148A-n.

At (8), one or more other vehicles 160A-n, e.g., vehicle 160 operating on the roads/streets proximate to vehicle 140, can be within receiving range of alarm signals 148A-n. Vehicle 160 can include an onboard vehicle detection system (VDS) 161 which can further include an onboard theft detection component 162 which can be configured to detect/receive the alarm signals 148A-n. The theft detection component 162 can be configured to, upon detection/receipt of alarm signals 148A-n, activate an onboard imaging component 164. The onboard imaging component 164 can be further configured to activate one or more cameras/sensors 165A-n to photograph vehicle 140 when vehicle 140 is in the field of view 163 of cameras/sensors 165A-n. Cameras/sensors 165A-n in conjunction with algorithms 166A-n can be configured to determine/“zero in” on the location of the source (e.g., transmitter 146) of the alarm signals 148A-n from vehicle 140. In an embodiment, the alarm signals 148A-n can include identifier information regarding vehicle 140 (e.g., make, model, colour, etc.) thus enabling the combination of cameras/sensors 165A-n, algorithms 166A-n, and imaging component 164 to identify vehicle 140 in a streetscape, and further tag vehicle 140 in any images 167A-n, etc., captured of vehicle 140. Cameras/sensors 165A-n can capture a series of images (e.g., digital images) 167A-n of vehicle 140, e.g., as long as vehicle 140 is in view. The imaging component 164 can be further configured to timestamp each image 167A-n regarding when the respective image was taken, and further tag images 167A-n with global positioning system (GPS) data 168 of the location at which the respective image 167A-n was taken. Information regarding the images 167A-n, e.g., GPS data 168, timestamps, vehicle tags, and suchlike, can be attached to/incorporated into an image 167A-n in the form of metadata. While the term GPS is utilized herein, any suitable navigation/location system can be utilized such as any of a global navigation satellite system (GNSS), GPS, Europe's Galileo, Global Navigation Satellite System (GLONASS), BeiDou Navigation Satellite System, Quasi-Zenith Satellite System (QZSS), an autonomous geo-spatial positioning system, or a satellite-based positioning, navigation and timing (PNT) system, and suchlike.

In an embodiment, VDS 161 can further include various algorithms 166A-n which can be respectively configured/trained to determine information, make predictions/inferences, etc., regarding any of identification, operation and/or location of vehicle 140, identification of occupant(s) (e.g., user 150, thief 155) of vehicle 140, image quality and resolution of images 167A-n, direction of focus/field of view of cameras/sensors 165A-n regarding location of vehicle 140, and suchlike. Algorithms 166A-n can include a computer vision algorithm(s), a digital imagery algorithm(s), algorithms for position prediction, velocity prediction, direction prediction, and suchlike, to enable image capture and generation of images 167A-n, as well as information to be compiled, and subsequently reviewed, regarding operation and/or location of vehicle 140, per the various embodiments presented herein.

At (9), the theft detection component 162 can be further configured to transmit the location/time-tagged images 167A-n to a remote external system 198 (as further described) and/or to the primary user device 111 (or a trusted user device 121A-n).

At (10) upon receipt of the location/time-tagged images 167A-n at the primary user device 111, the primary user 110 can identify whether they recognize any of the occupants 150 and/or 155 in the vehicle 140 present in the images 167A-n. In the event of recognizing the occupant 150, primary user 110 can authorize use of vehicle 140 by the occupant 150, at which point an authenticated notification 170G can be transmitted to user 150 indicating they are now treated as an authorized user 130A-n (with their user device operating as a user device 131A). Further, the authenticated notification 170G can be transmitted to the pairing component 142 on vehicle 140, and upon receipt, the pairing component 142/alarm component 145 can terminate transmission of the alarm signals 148A-n. In the event of vehicle 140 is no being longer tracked or observed by other vehicles 160A-n, the primary user 110 can receive a last seen location notification, wherein the last seen location can be generated from images 167A-n and associated time and GPS data 168 (e.g., the final, most recently generated image 167 of vehicle 140). The last seen location can be shared with other entities, e.g., external system 198, law enforcement entities, and suchlike.

In the event that the primary user 110 does not recognize the occupant 150 and/or 155 in images 167A-n, the user 150 (and/or thief 155) can still be considered as an unauthorized user, and vehicle 140 continues transmission of the alarm signals 148A-n.

As previously mentioned, when vehicle 160 (e.g., a second vehicle) is in close operational proximity to vehicle 140 (e.g., a first vehicle), the onboard imaging component 164 in conjunction with cameras/sensors 165A-n can capture images 167A-n of the vehicle 140. Multiple cameras/sensors 165A-n can be located about vehicle 160, such that the cameras/sensors 165A-n have an extensive field of view (e.g., 360 degrees around vehicle 160). A duration for which cameras/sensors 165A-n continue to take digital images of vehicle 140 can be based on various factors. In an embodiment, the imaging component 164 can be configured to analyze the images 167A-n (e.g., in conjunction with algorithms 166A-n) as they are generated to determine whether information captured in the images 167A-n can be utilized. For example, when vehicles 140 and 160 are proximate to each other, the images 167A-n may have sufficient information (e.g., are of a high enough resolution) for facial recognition to be conducted, enabling the one or more occupants (e.g., user 150, thief 155) to be identified. However, once a particular distance between vehicle 140 and vehicle 160 is of such a magnitude that facial recognition cannot be performed (e.g., distance is too great, respective faces are no longer in field of view of cameras 165A-n, and suchlike) the imaging component 164 can cease operation of cameras 165A-n, thereby terminating generation and transmission of images 167A-n from vehicle 160. In another embodiment, while the resolution of the digital images 167A-n is no longer sufficient to enable facial recognition, the imaging component 164 can be configured to maintain operation of cameras 165A-n to enable imaging of vehicle 140 such that, for example, the digital images 167A-n can be utilized to determine a direction in which vehicle 140 is being driven, whether vehicle 140 is no longer visible as it took a turn onto a cross street, the last seen location, parked, entered a building, merged onto a highway, and suchlike.

As previously mentioned, the once-deemed secure signaling technology incorporated in digital key fobs, etc., configured to access and start a vehicle has been compromised by various signaling devices available in the marketplace. Per the various embodiments presented herein, in a situation where the unknown user 150 has the particular key fob (or a counterfeiting device) required to operate vehicle 140 in their possession, an extra layer of security can be provided by requiring the unknown/currently unauthorized user 150 to (i) provide personal information and (ii) be authenticated prior to being granted the ability to access/operate vehicle 140. Also, the various embodiments presented herein provide a further layer of security. In the event of unknown user 155 is a car thief and has somehow been able to initiate operation of vehicle 140, per one or more embodiments presented herein regarding a requirement that the unknown user 155 has to be granted access by the primary user 110 or by any of the trusted users 120A-n, while the unknown user 155 is operating vehicle 140, unbeknownst to the unknown user 155, the primary user 110/trusted users 120A-n can deny authorization of access to vehicle 140 and further initiate the tracking process with generation of the alarm signals 148A-n.

In an embodiment, the remote/external system 198 can include a database (e.g., to archive the images 167A-n of vehicle 140 received from vehicles 160A-n) and further an administration system configured to review the images 167A-n, GPS location data 168, etc., to determine a route traveled by vehicle 140, where vehicle 140 may be currently located, etc. The remote external system 198 can further be in communication with other establishments/entities such as law enforcement, insurance agency, and suchlike, whereby the remote external system 198 can be configured to share with the other entities, etc., any information regarding vehicle 140, its operation, location, timing, authorized owners, etc., to enable the various entities to recover vehicle 140 in the event of theft/unauthorized use.

Further, regarding the various users presented in FIG. 1, as mentioned, the various embodiments can involve a primary user 110, wherein primary user 110 can be the owner of vehicle 140, while trusted users 120A-n and authorized users 130A-n are also users of vehicle 140. Primary user 110, trusted users 120A-n, and authorized users 130A-n can have a hierarchy of access rights and authorization abilities. In an embodiment, primary user 110 controls operation of authorized access to vehicle 140, whereby primary user 110 can (a) grant access to trusted users 120A-n and/or authorized users 130A-n, and (b) approve and/or deny an access request from user 150. Trusted users 120A-n are users who have been granted access to vehicle 140 by primary user 110 and also, if needed, assist primary user 110 in granting or denying access requests from user(s) 150. Authenticated users 130A-n are users who have been granted access to use vehicle 140 but do not assist primary user 110 in granting or denying access requests from user(s) 150.

In the event of primary user 110 not responding to an authentication request 125 in a timely manner (e.g., within a pre-configured time of 5-10 minutes), rather than the authentication request being flatly denied, the authentication request 125 can be forwarded to a trusted user 120A-n for them to grant/deny the authentication request 125. Hence, the authentication request 125 is forwarded through the hierarchy of a primary user (e.g., primary user 110) and trusted users (e.g., first trusted user 120A, second trusted user 120B, n^{th} trusted user 120n), wherein each user is tasked to respond to the authentication request 125 within a pre-configured time, or the next person in the hierarchy receives the authentication request 125. In the event that none of the primary user 110 or trusted users 120A-n responds to the authentication request 125, the authentication request 125 is denied with user 150 being denied access to vehicle 140.

During initiation of the system, initial pairing can be established between the primary user 110 and the vehicle 140, and pairing can remain in place between the primary user 110 and the vehicle 140 until canceled by the primary user 110. In an embodiment, any of the users authorized to access/operate vehicle 140 can initiate generation of alarm signals 148A-n (e.g., via their respective user device 111, 121A-n, 131A-n, 151), for example, where any of the users are involved in or see vehicle 140 being stolen/operated by an unauthorized user and/or thief.

As further shown, the UAS 141 of vehicle 140 and the VDS 161 of vehicle 160 can be respectively communicatively coupled with a respective onboard computer system (OCS) 149 and 169. In an embodiment, OCS 149 and OCS 169 can respectively be a vehicle control unit (VCU). OCS's 149 and 169 can be utilized to provide overall operational control, operation monitoring, and/or operation of vehicle 140 or 160.

With reference to vehicle 140, the various components of OCS 149 are further described. It is to be appreciated that the following components can be located on/incorporated into any of vehicle 140 or 160, as well as incorporated into any of the user devices (e.g., user devices 111 and 121A) utilized by any of the users 110, 120A-n, 130A-n, and 150, and/or external system 198. As shown in FIG. 1, OCS 149 can further include a processor 182 and a memory 184, wherein the processor 182 can execute the various computer-executable components, functions, operations, etc., presented herein. The memory 184 can be utilized to store the various computer-executable components, functions, code, etc., as well as user information in database 147, content of notifications 170A-n, content of authentication requests 125A-n, user personal information shared by a user with vehicle 140, images 167A-n, algorithms 166A-n, and suchlike (as further described herein).

As further shown, the OCS 149 can include an input/output (I/O) component 186, wherein the I/O component 186 can be a transceiver configured to enable transmission/receipt of information and data (e.g., notifications 170A-n, authentication requests 125A-n, personal information pertaining to a user, images 167A-n, and the like) between vehicle 140 and other systems and devices presented in system 100 (e.g., user devices 111, 121A-n, 131A-n, and/or 151, systems and components onboard vehicle 160, external system 198, and suchlike). I/O component 186 can be communicatively coupled, via an antenna 187, to the remotely located devices and systems. Transmission of data and information between the vehicle 140 (e.g., via antenna 187 and I/O component 186) and further between any of the remotely located devices and systems can be via the signals 190A-n. Any suitable technology can be utilized to enable the various embodiments presented herein, regarding transmission and receiving of signals 190A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like. For example, signals 190A-n can comprise of BLUETOOTH® technology between a user device (e.g., any of 111, 121A-n, 131A-n, 151) and vehicle 140, while signals 190A-n can comprise cellular technology for communications between any of the user devices (e.g., any of 111, 121A-n, 131A-n, 151), vehicle 140, vehicles 160A-n, external system 198, and suchlike.

In an embodiment, the OCS 149 can further include a human-machine interface (HMI) 188 (e.g., a display, a graphical-user interface (GUI)) which can be configured to present various information including any of notifications 170A-n, authentication requests 125A-n, authorization grant(s) and/or denial(s), personal information pertaining to a user, images 167A-n, information received from onboard and external systems and devices, etc., per the various embodiments presented herein. The HMI 188 can include an interactive display 189 to present the various information via various screens presented thereon, and further configured to facilitate input of information/settings/etc., regarding operation of the vehicle 140. In an embodiment, in the event of any of the users requesting access to vehicle 140 are unable to communicate via a user device (e.g., any of 111, 121A-n, 131A-n, 151), a screen 189 can be presented at vehicle 140 whereby the user can be prompted to enter a personal access code to initiate the authentication request process.

While the foregoing references cameras 165A-n being located and operating on vehicle 160, cameras 165A-n can further include sensors, wherein sensors/cameras 165A-n can include any suitable detection/measuring device, including cameras, optical sensors, laser sensors, Light Detection and Ranging (LiDAR) sensors, sonar sensors, audiovisual sensors, perception sensors, road lane sensors, motion detectors, velocity sensors, distance sensors (e.g., distance from vehicle 160 to vehicle 140), and the like, as employed in such applications as simultaneous localization and mapping (SLAM), and other computer-based technologies and methods utilized to determine an environment being navigated by vehicle 160, and the respective location of vehicle 160 and/or vehicle 140 within the environment (e.g., location mapping). As mentioned, images 167A-n, GPS/time data, and the like generated by sensors/cameras 165A-n can be analyzed by algorithms 166A-n to identify respective features of interest such as location of vehicle 140, lane markings, road signs, traffic junctions, etc.

As described herein, the various user devices 111, 121A-n, 131A-n, and 151 (and the respective components and sub-components included therein), can be communicatively coupled to vehicles 140 and 160A-n (and the respective components and sub-components included therein), and further communicatively coupled to the external system 198 (and the respective components and sub-components included therein), such that GPS data 168, authentication requests 125A-n, personal information, notifications 170A-n, images 167A-n, etc., can be shared (e.g., generated, transmitted, received, processed) by the respective systems, devices, and components, per the various embodiments presented herein.

FIG. 2, system 200 presents various components that can be utilized to authorize a user and prevent vehicle theft, in accordance with an embodiment. FIG. 2 further supplements the various components and systems described in system 100 with components that can be used to determine heart rate and stress of a user seeking authorization, wherein their stress can result from them being involved in a vehicle theft, for example.

As previously mentioned, a duration of time can be configured for which the primary user 110 is expected to respond to a user authentication request, e.g., authentication request 125A-n. A time component 280 can be incorporated into user device 111 such that a response duration 282 can be set (e.g., 5 minutes, 10 minutes, x minutes). The response duration 282 can be transmitted to a time component 285 at vehicle 140. The time component 285 can be configured to determine whether a response to an authentication request 125A-n has been generated by primary user 110 within the configured response duration 282. In the event that response duration 282 expires prior to receiving a response (e.g., an authentication granted/denied notification 170A-n) from primary user 110 (via user device 111), the time component 285 can be configured to access database 147, identify a first trusted user 120A, whereupon the unresolved authentication request 125A-n can be transmitted to the trusted user 120A for them to grant/deny the authentication request 125A-n, wherein the response duration 282 is now applied to trusted user 120A. In the event of response duration 282 expires prior to receiving a response (e.g., an authentication granted/denied notification 170A-n) from trusted user 120A, the time component 285 can be configured to access database 147, identify a second trusted user 120B, whereupon the authentication request 125A-n can be transmitted to the second trusted user 120B for them to grant/deny the authentication request 125A-n. If no one responds to grant/deny the authentication request 125A-n, the authentication request 125A-n remains in an ungranted/unresolved condition.

As previously mentioned, an example scenario can involve an attempt by user 150 to access vehicle 140 as a result of the user 150 being coerced into accessing vehicle 140 by a car thief 155. In an example scenario, user 150 may have even been previously granted access to vehicle 140. Owing to user 150 being coerced into accessing vehicle 140, user 150 can have an elevated heart rate. User device 151 can further include a physical condition component 255 which can be a heart rate monitor system configured to record the current heart rate 256 of the user 150, wherein user device 151 is further configured to transmit the heart rate 256 as a part of the user authentication request 125C. The authentication request 125C with the included heart rate 256 can be received at the UAS 141, such that while the user 150 has been previously granted access to operate vehicle 140, the user 150 being currently in a state of stress can be detected by the UAS 141. The heart rate 256 included in the authentication request 125 can be received by a physical condition component 210 incorporated into UAS 141.

In an embodiment, during a prior authentication of user 150, their heart rate was determined, e.g., the “at rest”/low stress heart rate 212 was determined and based thereon, the previously measured heart rate 212 forms a heart rate threshold 215, configured at the physical condition component 210.

While the current heart rate 256 of user 150 can be measured by the physical condition component 255, in another embodiment, the current heart rate 256 can be measured by a heart rate monitor incorporated into a seat in vehicle 140, e.g., in which user 150 sits when performing an authentication request 125A-n and/or while operating the vehicle 140.

The current heart rate 256 can be compared with the heart rate threshold 215. In the event of the current heart rate 256 being the same or higher than the heart rate threshold 215, a determination can be made, e.g., by physical condition component 210 (or by any of users 110 or 120A-n in a response to a suspicious heart rate notification 170) that the heart rate 256 is not at a normal level for user 150. Accordingly, in an embodiment, it does not matter if user 150 is currently able to be authenticated, by assessing the current heart rate 256, it can be determined that user 150 is undergoing a highly stressful situation, e.g., user 150 is being forced to access vehicle 140 by a thief (e.g., thief 155). The alarm component 145 can be configured to, in the event of receiving an over-threshold heart rate notification 270 generated and transmitted by the physical condition component 210, treat the authentication request 125 as suspicious. In response to receiving the suspicious heart rate notification 270, the alarm component 145 can initiate transmission of alarm signals 148A-n. In an embodiment, the user 150 may be authenticated and granted access to make the thief 155 believe that authorization has been granted to user 150, whereupon, the thief 155 subsequently operates vehicle 140 without knowledge that radio-frequency alarm signals 148A-n are being generated and transmitted, e.g., for detection by another vehicle 160, as previously described.

It is to be appreciated that utilizing the heart rate monitoring process to determine grant or denial of access of a vehicle can also be performed at any of user devices 111 or 120A-n. The heart rate 256 can be transmitted to any of user devices 111 or 120A-n, wherein a physical condition component 220 can be operating locally on the user device with functionality comparable to the physical condition component 210 regarding determination of the user's stressed condition relative to a threshold.

To provide further context regarding the various embodiments presented herein, example scenarios of use include, in a non-limiting list, any of:

Thief 155 has accessed/operating vehicle 140 directly, e.g., the engine of vehicle 140 was running with a door of vehicle 140 unlocked. Hence, thief 155 accessed the vehicle 140 and is now operating it. Any of the users 110, 120A-n, 130A-n authorized to access/operate vehicle 140 can generate and transmit an alarm notification 170A (e.g., via their respective user device, e.g., primary user 110 initiates the alarm notification 170A via device 111) which is transmitted to, and received by, the UAS 141 on vehicle 140. Accordingly, the alarm notification 170A causes alarm component 145 to be activated, with alarm signals 148A-n being transmitted from vehicle 140 for receipt by other vehicles (e.g., vehicle 160) which are configured to record operation of vehicle 140, e.g., with digital images 167A-n which can be subsequently transmitted to an authorized user (e.g., any of users 110, 120A-n, 130A-n, 150) or the remote external system 198, as previously described.

In another example, any authorized user (e.g., any of users 110, 120A-n, 130A-n, 125) can configure a time window for which they will not be operating vehicle 140. For example, primary user 110 is currently using vehicle 140 and has driven vehicle 140 to a location where they will not require to operate vehicle 140 for a period of time, such as primary user 110 is at work, at a shopping mall, a restaurant, a football match, and suchlike. Primary user 110 can utilize the time component 280 on device 111 to configure a duration of time 284 such that if vehicle 140 is moved during time 284, UAS 141 can detect motion of vehicle 140 (e.g., by motion sensors 290, ignition system sensor, motor ignition sensor, and suchlike) and based thereon, UAS 141 can determine that vehicle 140 is being moved and the alarm component 145 can be activated, alarm signals 148A-n transmitted from vehicle 140 for receipt by other vehicles (e.g., vehicle 160), with according tracking of vehicle 140 occurring, as previously described. In a scenario where primary user 110 forgot to terminate the time 284 prior to moving vehicle 140, a notification can be presented on user device 111 or at the vehicle 140 (e.g., on screen 189) informing primary user 110 that the time component 285 needs to be cancelled. Cancellation of time duration 284 (e.g., at the time component 280) can be via HMI 188, however, cancellation of time duration 284 can be configured such that it can only be performed via user device 111 so as to prevent whoever is driving vehicle 140 from terminating operation of the alarm component 145.

In another example where the thief 155 has accessed/is operating vehicle 140 directly, e.g., the engine of vehicle 140 was running with a door of vehicle 140 unlocked. Hence, thief 155 accessed the vehicle 140 and is now operating it. While vehicle 140 currently has no knowledge of the identity of the person 155 operating vehicle 140, the onboard heart rate monitor (e.g., located in the seat) can determine the heart rate of the user 155 is elevated, wherein the physical condition component 210 determines the heart rate is at or above a threshold (e.g., an arbitrary threshold based on, for example, an average “normal” heart rate for a population), which accordingly triggers operation of the alarm component 145.

In another example scenario, vehicle 140 can be part of a rideshare operation, wherein users can request a driver transport them from one location to another. In another example scenario, vehicle 140 can be a taxi service or similar operation. Conventionally, rideshare vehicles and taxis have a driver and operate in a non-autonomous or partially autonomous manner. However, as autonomous vehicles are beginning to find application as driverless taxi's, rideshare vehicles, etc., a scenario can occur where a user 150 is requesting transportation by such vehicles, an issue can arise where one or more potential users are not authorized be an occupant in vehicle 140. For example, a user 150 is requesting a rideshare to evade person 155. During a prior transport request, user 150 can have provided their heart rate (which is stored in database 147 and used as a threshold 215). Accordingly, owing to the stressful situation, user 150's heart rate is elevated, and accordingly, per the various embodiments presented herein, the current heart rate 256 of user 150 can be compared with the heart rate threshold 215 and in response to a determination of the heart rate being elevated, transmission of the alarm signals 148A-n can be initiated. In another scenario, during the rideshare hailing by user 150, user 150 can identify that they will be the only occupant for the duration of the journey. However, person 155 may get in the vehicle 140 against the wishes of user 150. Cameras/sensors (e.g., similar to cameras/sensors 165A-n) onboard vehicle 140 can determine (e.g., in conjunction with pairing component 142) the number of occupants in the passenger compartment of vehicle 140, and in the event that more than the anticipated number are present, (e.g., both user 150 and person 155 rather than just user 150) the alarm component 145 can be activated and transmission of alarm signals 148A-n initiated.

Hence, in a typical operating scenario where authentication has been conducted, a user (e.g., any of users 110, 120A-n, 130A-n) can be treated as an authorized user while the user is operating vehicle 140, e.g., as a driver (where vehicle 140 is operating as a non-autonomous vehicle or a partially autonomous vehicle) or an occupant (where vehicle 140 is operating as a fully autonomous vehicle).

It is to be appreciated that the various scenarios of use of vehicle 140 are myriad, and any scenario is applicable where vehicle 140 is being operated in an unauthorized manner such that alarm signals 148A-n can be activated at and transmitted from vehicle 140 for detection by other vehicles (e.g., vehicle 160) with the according photography and location identification of vehicle 140, as previously described.

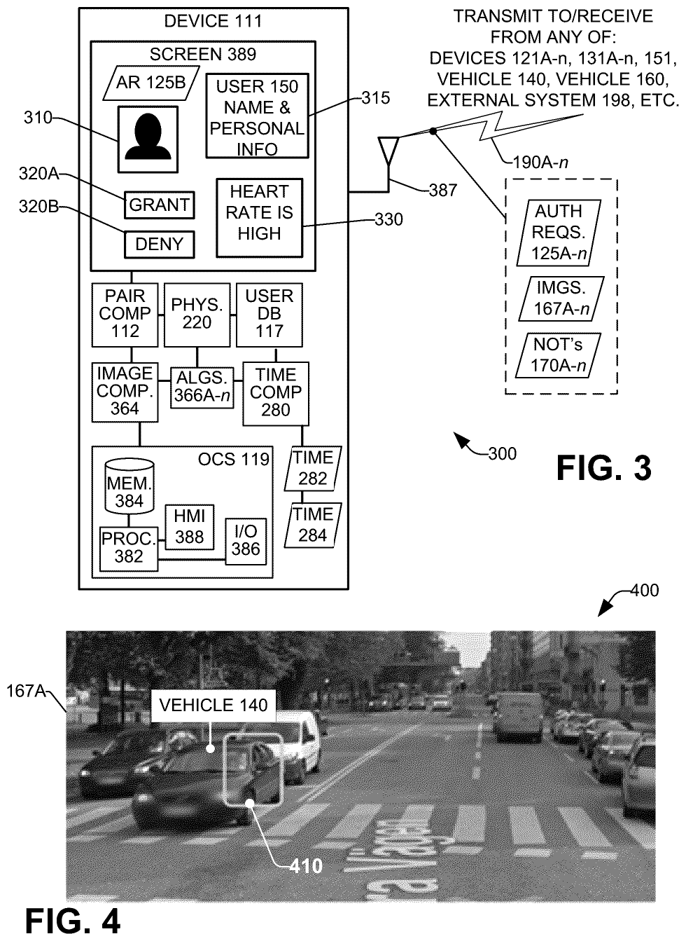

FIG. 3, schematic 300 illustrates a user device which can be utilized to grant/deny an authentication request, in accordance with an embodiment. Device 111 presented in FIG. 3 at a moment when a primary user 110 is able to grant or deny an authentication request. In an embodiment, and as previously mentioned, device 111 comprises components comparable in operation and function as those present in OCS 149 and/or 169, e.g., a processor 382, memory 384, an I/O component 386, an antenna 387, a HMI 388, and a screen(s) 389 respectively comparable to processor 182, memory 184, I/O component 186, antenna 187, HMI 188, and screen(s) 189. As previously mentioned, device 111 can be in communication with other devices and systems, e.g., devices 121A-n, 131A-n, and 151, systems and components onboard vehicles 140 and 160, and the external system 198. Device 111 can receive information/data and transmit information/data, wherein the information/data can include authentication requests 125A-n (and personal information, heart rate(s), etc.), images 167A-n, notifications 170A-n, and suchlike.

As shown in FIG. 3, elements received in an authentication request 125B are presented on device 111, wherein screen 389 presents an image 310 of the person requesting authentication (e.g., user 150), their personal information 315 including name, identity number, and suchlike, as previously described. Buttons 320A and 320B, which when selected, respectively grant or deny the authentication request 125B. Further, health indicator 330 indicates that the heart rate (e.g., current heart rate 256) of the user who submitted the authentication request 125B is above a threshold (e.g., threshold 215 based on prior heart rate 212). Based on the foregoing, primary user 110 can make a determination on whether to grant the authentication request 125B, and in response to detecting selection of grant button 320A or deny button 320B, a notification (e.g., a notification 170P) can be generated by the pairing component 112 and transmitted to a remote device/system such as user device 151 and/or UAS 141 onboard vehicle 140. The notification 170P can be processed at the receiving system, with the requesting user (e.g., user 150) being granted access to vehicle 140, or the UAS 141 may cause an alarm signal 148A-n to be generated, as previously described.

In an embodiment, and as further described herein, an image component 384 can be configured to receive and process any of the images 167A-n (e.g., in combination with algorithms 366A-n, wherein algorithms 366A-n can include the same functionality, etc., as previously described algorithms 166A-n), whereby the image component 384 can be configured to present the images 167A-n on screen 389 for review by the primary user 110, e.g., to determine whether they can identify one or more occupants in vehicle 140. Image component 384 can be configured, in conjunction with screen 389, to present information received (e.g., route information, last seen location, GPS data 168, timestamps, etc.) regarding subsequent use of vehicle 140, e.g., during unauthorized operation.

As shown in FIG. 3, device 111 can further include the physical condition component 220 and the time component 280, respective operation of which was previously described in FIG. 2.

Turning to FIG. 4, image 400 presents an example image that can be captured and analyzed, in accordance with one or more embodiments. As previously mentioned, image 400 can be presented on screen 389 of device 111 (and also on devices 121A-n and 131A-n of trusted users 120A-n and authenticated users 130A-n) and also on a screen(s) at external system 198. As shown, image 400 comprises a digital image 167A which includes the vehicle 140 being driven in an alarmed state. In an embodiment, the vehicle 140 can be tagged/identified within the image 167A. As further shown, a portion 410 of the image 167A has undergone analysis (e.g., by imaging component 164 and algorithms 166A-n) with facial imagery enabling the driver to be located in the images 167A. As previously mentioned, capture of images 167A-n by vehicle 160 can be undertaken while useful information (e.g., identity of user(s) 150, 155, presence of vehicle 140) is being obtained. As further mentioned, in the event that the primary user 110 recognizes the user within the portion 410, primary user 110 can generate an authorized notification 170A-n causing transmission of the alarm signals 148A-n to be ceased at vehicle 140. Further, in the event of the primary user 110 does not recognize the user within the portion 410, vehicle 140 continues to generate and transmit the alarm signals 148A-n.

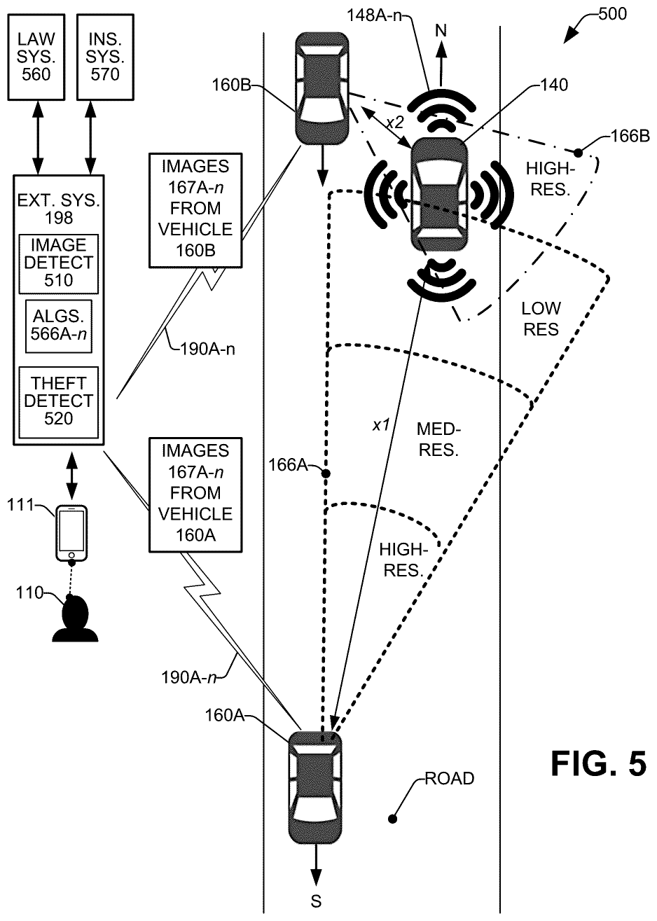

FIG. 5, schematic 500 illustrates a vehicle being located by one or more other vehicles, in accordance with an embodiment. FIG. 5 is a snapshot in time of various vehicles navigating a road. A first vehicle 140 is driving north on the road, while vehicles 160A and 160B are driving south. At an initial moment vehicle 160A was proximate to vehicle 140 but over time has driven further away from vehicle 140, such that vehicle 160B is now proximate to vehicle 140. As previously described, vehicle 140 is transmitting alarm signals 148A-n, whereby theft detection components 162A and 162B respectively onboard vehicles 160A and 160B are configured to initiate image capture of vehicle 140.

An imaging system onboard vehicle 160A, comprising an imaging component 164A, cameras 165A, and imaging algorithms 166A, is capturing images 167A-n from field of view 163A. The images 167A-n from vehicle 160A can be transmitted (e.g., in signals 190A-n) to the user device 111 of the primary user 110 (or trusted users 120A—or authorized users 130A-n), and also to the external system 198. In an embodiment, external system 198 can be a computer system, database, etc., that is remotely located, e.g., a cloud-based computing system. As shown, the external system 198 can forward image 167A-n and pertinent information, e.g., GPS data 168, timestamps, last seen location, and suchlike, to a computer system 560 located at a law enforcement establishment and/or a computer system 570 located at an insurance agency (e.g., insurers of vehicle 140).

An imaging system onboard vehicle 160B, comprising an imaging component 164B, cameras 165B, and imaging algorithms 166B, is capturing images 167A-n from field of view 163B. The images 167A-n from vehicles 160B can be transmitted (e.g., in signals 190A-n) to the user device 111 of the primary user 110 (or trusted users 120A—or authorized users 130A-n), and also to the external system 198.

As previously described, primary user 110 can review the images 167A-n received from vehicles 160A and 160B, presented on user device 111, to determine whether primary user 110 recognizes the person (e.g., user 150, thief 155) in vehicle 140, wherein the person can be authenticated or denied authentication.

The images 167A-n from vehicles 160A and 160B can be transmitted (e.g., in signals 190A-n) to the user device 111 of the primary user 110 (or trusted users 120A—or authorized users 130A-n), and also to the external system 198. As previously described, primary user 110 can review the images 167A-n received from vehicles 160A and 160B to determine whether primary user 110 recognizes the person (e.g., user 150, thief 155) in vehicle 140, wherein the person can be authenticated or denied authentication.

Further, an image detection system 510 can be included in the external system 198, wherein the image detection system 510 can be configured to review the images 167A-n received from vehicles 160A and 160B. Image detection system 510 can utilize algorithms 466A-n to analyze the images 167A-n, wherein algorithms 566A-n can include the same functionality, etc., as previously described algorithms 166A-n. Images 167A-n, and information pertaining thereto (e.g., GPS data 168, timestamps) can also be shared between the user device 111 and the external system 198.

As further shown in FIG. 5, and as previously described, as respective vehicles 160A and 160B transition from being proximate to vehicle 140 and then distant from vehicle 140, the quality of the images 167A-n can reduce in quality/resolution. Hence, at the moment in time presented in FIG. 5, vehicle 160A is at such a distance from vehicle 140 that the image quality of images 167A-n being obtained at vehicle 160A are transitioning from high quality/resolution to medium quality/resolution to low quality/resolution, while, given the proximity of vehicle 160B to vehicle 140, the image quality of images 167A-n being obtained at vehicle 160A are currently of a high resolution. Hence, at the moment presented in FIG. 5, the images 167A-n generated by vehicle 160B are of higher quality and can be prioritized for image analysis (e.g., by image detection system 510, or presented on user device 111) over the images 167A-n generated by vehicle 160A. However, in the event that only vehicle 160A is present at the given moment (e.g., vehicle 160B has still yet to drive along that portion of the road), then image analysis can defer to the images 167A-n generated by vehicle 160A as they may be the only images that show the last seen location of vehicle 140. In a embodiment, as new images 167A-n become available, the last seen location identifier can be updated accordingly to take the most recent location/time of detection of vehicle 140.

In another embodiment, the respective distance of the respective vehicles 160A and 160B can be utilized to prioritize processing of the images (e.g., by image detection component 510) wherein given distance x1 from vehicle 160A to vehicle 140 is greater than distance x2 from vehicle 160B to vehicle 140, images 167A-n received from vehicle 160B are given priority of processing than images 167A-n received from vehicle 160A. In an embodiment, the respective distances x1 and x2 can be determined from the GPS data 168 associated with each image, from the respective size of vehicle 140 in each image 167A-n (e.g., the further the distance from vehicle 140 the smaller the depiction of vehicle 140 in an image), and further, cameras/sensors 165A-n onboard each of vehicles 160A and 160B can include a distance sensor which can determine the distance between the respective vehicle and vehicle 140, wherein the respective images 167A-n can be tagged with the distance measurement.

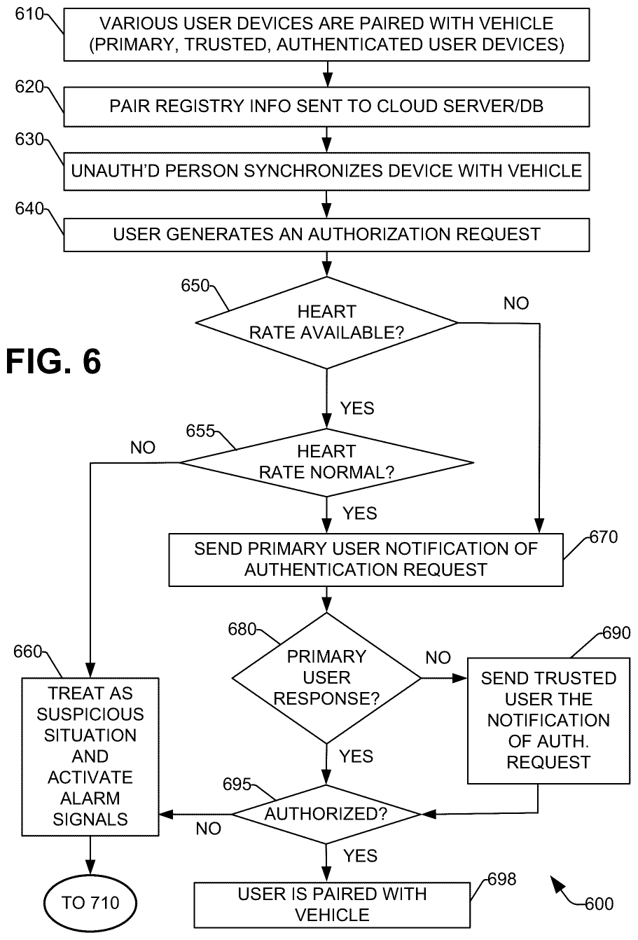

FIG. 6 illustrates a flow diagram 600 for a computer-implemented methodology to grant or deny access to a vehicle, in accordance with at least one embodiment.

At 610, a first vehicle (e.g., vehicle 140) is paired with respective devices owned by respective users (e.g., user device 111 owned/operated by primary user 110, user device 121A owned/operated by trusted user 120A, user device 131A owned/operated by authorized user 130A, etc.).

As previously mentioned, a primary user (primary user 110) has the ability to oversee/authenticate the pairing operation between a user device and the first vehicle, as well as authorize use of the first vehicle. Trusted users (e.g., trusted users 120A-n) also have approval authority in the event that a primary user is unavailable to approve an access request (e.g., primary user 110 is unavailable due to being in a meeting and does not have access to their user device 111). Any suitable technology to can be utilized to pair the user devices with the first vehicle. In an embodiment, a user device can be paired directly with the first vehicle, e.g., via BLUETOOTH® or similar pairing technology. As part of the pairing process, personal information of the user is shared between the user device and the first vehicle.

In another embodiment, the pairing process can further include obtaining a measure of the heart rate of the user requesting authorization and access. For example, the user device can be a smartwatch or suchlike configured to obtain a measure of the user's heart rate. As previously mentioned, when a user is under stress such as when being car-jacked, their heart rate is expected to increase. The “at rest” heart rate can function as a heart rate threshold utilized by a physical condition component (e.g., physical condition component 210 located on the first vehicle). During operation of the first vehicle, a user's heart rate can be assessed by the smartwatch, an onboard heart rate monitor built into a seat located onboard the first vehicle, etc.

At 620, the pairing information obtained during the pairing process can be transmitted to an external system (e.g., external system 198 having a database/administration system) as well as stored in a database at the first vehicle (e.g., database 147), a database on a user device (e.g., database 117 on user device 111), and suchlike.

At 630, a user (e.g., user 150) can attempt to initiate use of the first vehicle. Depending upon a particular scenario of operation, the user can be any of a previously authorized user that is attempting to operate the first vehicle once again, a user who has not been previously authorized and is wanting to gain access/operate the first vehicle. However, the user requesting authorization may be a thief, or being threatened by a thief, and suchlike. Hence, regarding FIGS. 5 and 6, as the status of the user is defined/determined, the user can respectively be referred to as an unknown user, an unauthorized user, an authorized user, an active user, etc.

In an embodiment, the requesting user can utilize a pairing component operating on their user device (e.g., pairing component 152 of user device 151) to attempt synchronization with a pairing component located at the first vehicle (e.g., pairing component 142 onboard vehicle 140). Upon successful user device-vehicle synchronization pairing establishing communications between the user device and the vehicle, methodology 600 can advance to step 640.

At 640, an authentication request can be generated by the pairing component on the user's device (e.g., pairing component 152), wherein the authentication request can include the requesting user's personal information (e.g., authentication request 125B including user 150's personal information, which may or may not include their heart rate 256) and transmitted from the user device to the first vehicle.

At 650, a determination can be made as to whether a current heart rate (e.g., heart rate 256) for the user can be obtained. As mentioned, a measure of a user's heart rate may be obtained from a heart rate sensor in their user device, a heart rate sensor in the first vehicle being accessed, and suchlike. In an embodiment, knowing the current heart rate can be useful where the user requesting re-authentication is known to the system and a “normal”/“at rest” heart rate value (e.g., heart rate 212, as used to establish the heart rate threshold 215) has been previously obtained for the user during a prior authentication process (e.g., by physical condition component 210). In response to a determination (e.g., by physical condition component 210) of NO current heart rate data is available, where user 120 has previous no heart rate data available, methodology 600 can advance to step 670. In response to a determination (e.g., by physical condition component 210) of YES heart rate data is available from a prior authentication methodology 600 can advance to 655.

At 655, the current heart rate (e.g., heart rate 256) can be compared with the heart rate threshold (e.g., heart rate threshold 215) configured for the physical condition component (e.g., by physical condition component 210) located onboard the first vehicle. In the event of the current heart rate being the same or higher than the heart rate threshold, a determination can be made (e.g., by the physical condition component 210) that NO, the heart rate is not at a normal level for the user. Accordingly, even if the user is able to be authenticated, by assessing the current heart rate, it can be determined (e.g., by the physical condition component 210) that the user is undergoing a highly stressful situation, e.g., the user is being forced to access the vehicle by a thief (e.g., thief 155).

Methodology 600 can advance to 660 wherein the requesting user's situation can be treated as suspicious and while the user may be authenticated (e.g., in a scenario to fool the thief 155 into thinking that authorization has been granted to user 150) transmission of alarm signals (e.g., alarm signals 148A-n) can be initiated.

Returning to step 655, in response to a determination that YES the user's heart rate is normal, methodology 600 can continue to 670, whereupon the authentication request can be forwarded to the primary user (e.g., received at user device 111) for approval or denial of the requesting user. It is to be noted that the authentication request can be forwarded to the primary user prior to a determination of whether a heart rate value is available. In another embodiment, the authentication request can be forwarded once the normal/abnormal heart rate determination is performed, such that the authentication request can be accompanied with an indication of whether the heart rate is normal or abnormal.

At 680, a duration (e.g., time 282) can be configured for which the primary user is to respond to the user request. In the event of YES, the primary user responded within the predefined duration, methodology 600 can advance to 695.

At 695, a determination can be made as to whether the user request was granted by the primary user. For example, an access grant/deny notification (e.g., notification 170A) can be generated (e.g., by pairing component 112) and transmitted by the primary user via their user device. The notification can be received by the pairing component (e.g., pairing component 142) located on the first vehicle. At 695, in the event of the access notification indicating that YES, the user request has been authorized, methodology 600 can advance to 698, whereupon the user can be granted access to operate the first vehicle.

At 695, in the event of the access notification indicates NO, the user request has not been authorized, methodology can advance to 660, wherein, as previously described, the access request situation can be treated as suspicious and while the user may be authenticated (e.g., in a scenario to mistake the thief 155 into thinking that authorization has been granted to user 150) transmission of alarm signals (e.g., alarm signals 148A-n) can be initiated.

Returning to 680, in the event of the primary user response is not received within a defined time period (e.g., time 282), methodology 600 can advance to 690, whereupon, the authentication request can be forwarded (e.g., by pairing component 142) to a trusted user (e.g., trusted user 120A-n). As previously mentioned, the trusted user can grant or deny the user request on behalf of the primary user. Methodology can advance to 695, for a determination of whether the authentication notification has been granted, as previously described.

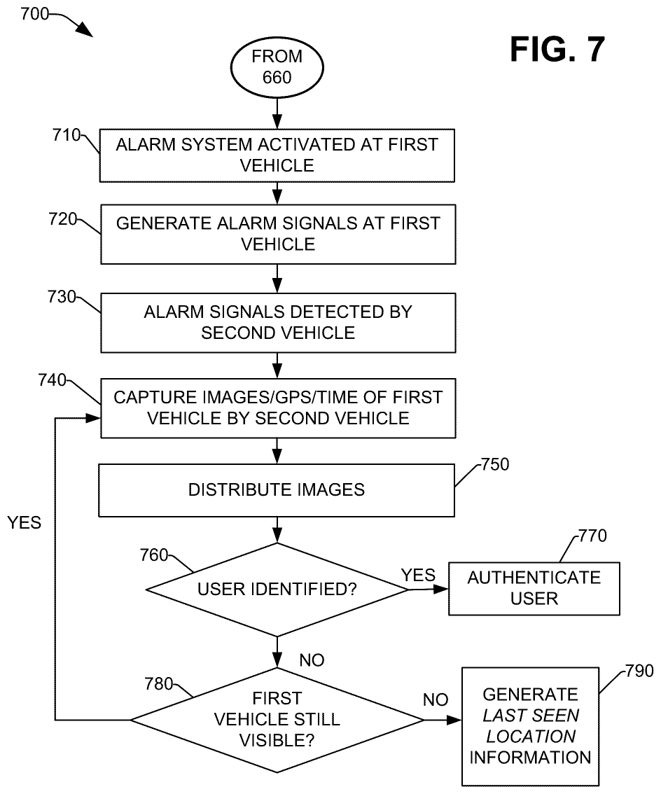

FIG. 7 illustrates a flow diagram 700 for a computer-implemented methodology to capture and record operation of a vehicle, in accordance with at least one embodiment. FIG. 7 is a continuation of step 660 of FIG. 6, methodology 600.

At 710, the alarm system (e.g., alarm component 145) onboard the first vehicle (e.g., vehicle 140) can be activated to generate and transmit alarm signals (e.g., alarm signals 148A-n). Activation of the alarm system can be initiated in response to a notification generated by the primary user (e.g., primary user 110) and/or a suspicious activity notification generated by the pairing component located onboard the first vehicle (e.g., pairing component 142).

At 720, the alarm signals can be transmitted from the first vehicle. The alarm signals can be generated by any suitable technology, e.g., radio frequency technology.

At 730, a second vehicle (e.g., vehicle 160) can be operating local to the first vehicle, wherein the second vehicle detects (e.g., by theft detection component 162) the alarm signals.

At 740, in response to detecting the alarm signals, an imaging system (e.g., imaging component 164 and camera/sensors 165A-n) can be activated to capture information (e.g., images 167A-n, GPS data 168, time information, etc.) pertaining to the first vehicle. For example, as the second vehicle drives by and/or is proximate to the first vehicle, a camera system onboard the second vehicle can take digital images (e.g., images 167A-n) of the first vehicle.

At 750, the images, tagged with GPS/location data and time at which the respective image was taken, can be distributed by the second vehicle. In an embodiment, the images can be transmitted to an external system (e.g., external system 198) where the images can be archived and also distributed to law enforcement, insurance agency, and suchlike. The images can also be forwarded to any of the users (e.g., users 110, 120A-n, 130A-n, and/or 150) authorized to operate the first vehicle, wherein the respective users can review the images (e.g., on their respective user devices 111, 121A-n, 131A-n, and/or 151) to determine whether they recognize one or more occupants of the first vehicle.

At 760, a determination can be made regarding whether the one or more occupants are known to any of the users reviewing the images. In response to a determination of YES, an occupant is recognized, methodology 700 can advance to 770, wherein the person (e.g., in the event of the person is a primary user 110 or a trusted user 120A-n) who identified an occupant can authenticate (e.g., via pairing component 112, 122A) the occupant (e.g., person 150) to use the first vehicle. Alternatively, operation of the first vehicle can be denied the primary user or trusted user (e.g., via the pairing component 112, 122A) and capturing of the images of/tracking the first vehicle can be maintained.

At 760, in response to a determination of NO occupant has been identified, methodology 700 can advance to 780 wherein a determination can be made regarding whether the first vehicle is still present in the images (e.g., at a resolvable resolution/image clarity) and hence, the first vehicle is still visible to the second vehicle. The determination regarding the presence of the first vehicle in the images can be performed by various imaging algorithms and suchlike (e.g., algorithms 166A-n) available to the imaging system (e.g., available to the imaging component 164). In response to a determination (e.g., by imaging component 164) that the first vehicle is still visible/present in the images, methodology 700 can return to 740 for further images to be captured by the second vehicle. In an embodiment, where first vehicle is being photographed by more than one vehicle, the images respectively generated by each vehicle can be prioritized based on the image quality of the respective images. For example, a third vehicle may pass by the first vehicle closer than the second vehicle, and accordingly, images generated by the third vehicle may have better detail/resolution than the images generated by the second vehicle. In another example, the imaging system on the second vehicle may be better (e.g., generates higher resolution images) than the imaging system on the third vehicle, thus, the images from the second vehicle are prioritized.

At 780, in response to a determination (e.g., by imaging component 164) that the first vehicle is NO longer visible to the second vehicle (or any other vehicle configured to take images of the first vehicle in response to an alarm signal being detected), the respective images can be reviewed (e.g., by the theft detection component 162) in conjunction with GPS and time data to identify a last seen location of the first vehicle. This operation can also be performed at the external system (e.g., external system 198) based on the respective images received from the entirety of vehicles (e.g., vehicles 160A-n) that were in the vicinity, and took images, of the first vehicle. The last known location and images pertaining to the first vehicle can be forwarded to the primary/trusted users and/or to law enforcement, insurance agency, and suchlike, for further actions to be taken to recover the first vehicle.

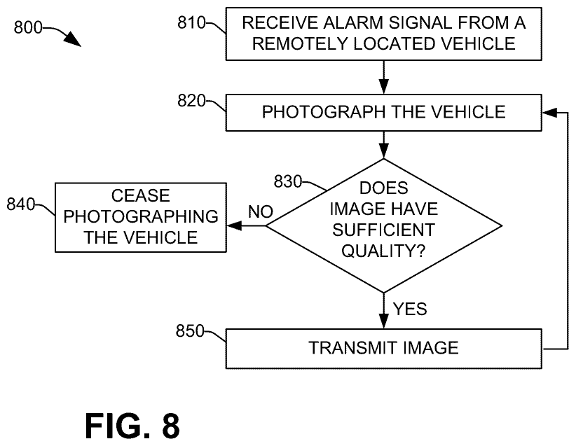

FIG. 8, illustrates a flow diagram 800 for a computer-implemented methodology to capture and record operation of a vehicle, in accordance with at least one embodiment.

At 810, one or more alarm signals (e.g., alarm signals 148A-n) can be received at a vehicle (e.g., at theft detection component 162 onboard vehicle 160), wherein the alarm signals are generated by a remotely located vehicle (e.g., vehicle 140).

At 820, in response to the received alarm signals, an imaging system (e.g., imaging component 164 and cameras/sensors 165A-n operating with algorithms 166A-n) can be activated at the vehicle to photograph the remote vehicle. The images can be tagged with location data (e.g., GPS data 168) and a timestamp indicating where and when the image was taken, as well as an inference of the location of the remote vehicle at the time the respective image was generated.

At 830, each image (e.g., in images 167A-n) can be analyzed to determine whether the image has sufficient image quality to determine an occupant (e.g., by a facial recognition algorithm 166A-n) of the remote vehicle and/or presence of the remote vehicle in the image (e.g., by a vehicle recognition algorithm 166A-n). In response to a determination that the respective image NO longer has sufficient resolution and/or the remote vehicle is no longer in the image, methodology 800 can advance to 840, wherein the imaging system (e.g., imaging component 164) can be configured to cease image capture of the remote vehicle. In an embodiment, the imaging system can be configured to tag/label/identify the last image having the remote vehicle visible therein with a last image and/or last seen location tag, to enable subsequent analysis of a route driven by the remote vehicle and/or the last seen location at which the vehicle was visible/spotted by any vehicle that may have driven by the remote vehicle.

Returning to 830, in response to a determination that the respective image YES, does have sufficient resolution and/or the remote vehicle is still in the image, methodology 800 can advance to 850, wherein the imaging system (e.g., imaging component 164) can be configured to maintain capturing images of the remote vehicle. Methodology 800 can return to 820 for the next image to be taken of the remote vehicle.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In this particular embodiment, the imaging components 164, 364, and 510 and the associated algorithms 166A-n, 366A-n, 566A-n can include machine learning and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process for determining (a) the presence of vehicle 140 proximate to vehicle 160A-n, (b) presence of vehicle 140 in the images 167-n, (c) is vehicle 160A generating more useful images than vehicle 160B? (d) determination of last seen location, etc., can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed (e.g., capturing of vehicle 140 in images 167A-n and subsequent location determination).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria a location of vehicle 140, for example.

### EXAMPLE APPLICATIONS AND USE

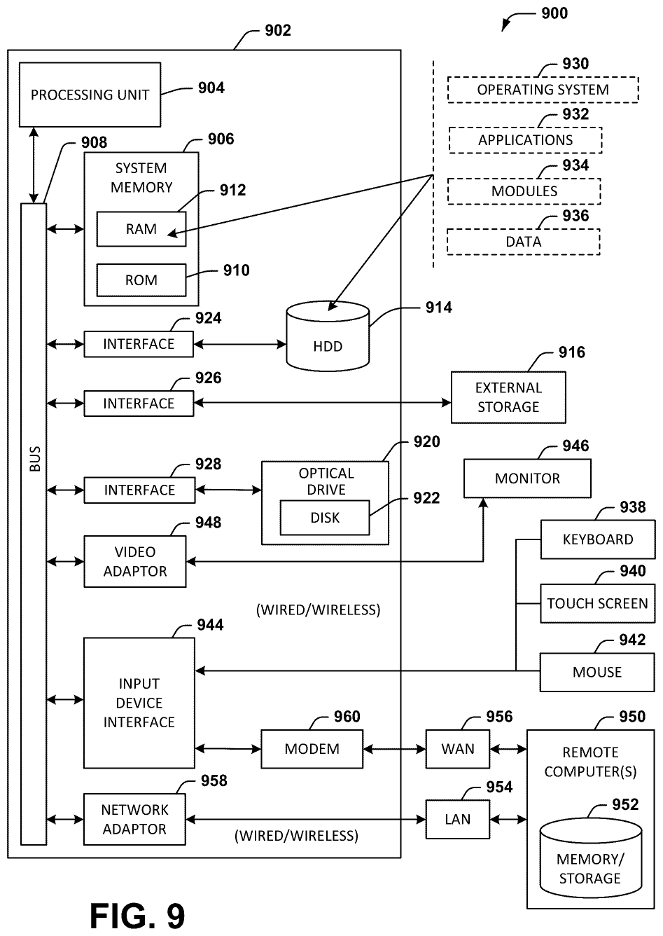

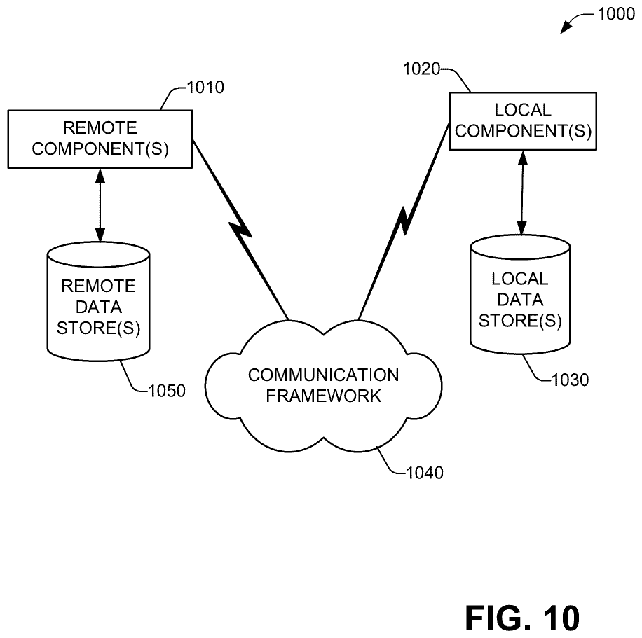

Turning next to FIGS. 9 and 10, a detailed description is provided of additional context for the one or more embodiments described herein with FIGS. 1-8.

In order to provide additional context for various embodiments described herein, FIG. 9 and the following discussion are intended to provide a brief, general description of a suitable computing environment 900 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors and may include a cache memory. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can comprise a security module, such as a trusted processing module (TPM). For instance with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1094 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 10, an illustrative cloud computing environment 1000 is depicted. FIG. 10 is a schematic block diagram of a computing environment 1000 with which the disclosed subject matter can interact. The system 1000 comprises one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010 and 1020, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A user device comprising:
a memory that stores computer executable components; and
a processor that executes the computer executable components stored in the memory, wherein the computer executable components comprise:
a pairing component configured to:
receive an authentication request from a first vehicle, wherein the authentication request includes information regarding a first user, wherein the first user wants to operate the first vehicle;
present the authentication request at the user device; and
receive a first input, wherein the first input indicates whether the authentication request has been granted or denied.

2. The user device of claim 1, wherein the pairing component is further configured to:
in the event of the first input indicates the authentication request has been denied:
generate a first notification indicating the authentication request is denied; and
transmit the first notification to the first vehicle; or
in the event of the first input indicates the authentication request has been approved:
generate a second notification indicating the authentication request is approved; and
transmit the second notification to the first vehicle.

3. The user device of claim 2, further comprising an image component configured to:
receive one or more digital images, wherein the digital images include at least one of a depiction of the first vehicle or depiction of an occupant of the first vehicle.

4. The user device of claim 3, wherein the one or more images are received from a second vehicle, wherein the second vehicle captured the one or more images in response to an alarm signal generated by the first vehicle, wherein generation of the alarm signal is based at least in part on the second notification being received at the first vehicle.

5. The user device of claim 4, wherein the pairing component is further configured to:
receive a second input, wherein the second input indicates recognition of the first user; and
in response to receiving the second input, generate a third notification, wherein the third notification indicates the occupant of the first vehicle and the first user are the same and the authentication request is granted.

6. The user device of claim 4, wherein the imaging component is further configured to receive a last seen location notification, wherein the last seen location notification indicates a most recent position identified for the first vehicle.

7. The user device of claim 1, wherein the user device is a smart device comprising a cellphone, a smartwatch, or a tablet computer.

8. The user device of claim 1, wherein the first user information includes at least one of a name, an address, a photograph of the first user, or a unique identifier of the first user.

9. The user device of claim 1, further comprising a time component configured to:
configure a duration of time for which the first input is to be received at the authentication request is presented on the user device; and
in the event of the first input is not received within the duration of time, the first input can no longer be received at the user device.

10. The user device of claim 1, wherein the pairing component is further configured to receive a notification of a heart rate of the first user, wherein the heart rate is indicated to be above a threshold value or below the threshold value.

11. A method comprising:
transmitting, by a user device comprising a processor, an authentication request denial to a first vehicle, wherein the authentication request denial denies use of the first vehicle by a first user;
receiving, at the user device, a digital image of the first vehicle, wherein the digital image is generated by an imaging system located onboard a second vehicle, wherein the first vehicle is being operated in contravention of the authentication request denial; and
presenting the digital image on the user device, wherein the digital image further comprises metadata indicating at least one of a GPS location of where the digital image was taken, a time when the digital image was generated, a vehicle occupant, or an identifier of the first vehicle.

12. The method of claim 11, further comprising:
determining a location of the first vehicle based on at least one of the digital image GPS location or the time when the digital image was generated.

13. The method of claim 12, wherein the authentication request included information regarding the first user.

14. The method of claim 13, further comprising:
presenting the first user information on the user device; and
receiving an input at the user device, wherein the input is from a second user indicating the authentication request from the first user was accepted or denied based at least in part on the first user information, wherein the user device is a smart device, a cellphone, a smart watch, or a tablet computer.

15. The method of claim 14, wherein the first user information further comprises an indication of whether the first user was in a state of stress when the authentication request was generated, wherein the stress indication is based on a heart rate of the first user when the authentication request was generated.

16. A computer program product comprising a computer readable storage medium having program instructions embodied therewith, the program instructions executable by a processor to cause the processor to:
transmit, from a user device, an authentication request denial to a first vehicle, wherein the authentication request denial denies use of the first vehicle by a first user;
receive, at the user device, a digital image of the first vehicle, wherein the digital image is generated by an imaging system located onboard a second vehicle, wherein the first vehicle is being operated in contravention of the authentication request denial; and
present the digital image on the user device, wherein the digital image further comprises metadata indicating at least one of a GPS location of where the digital image was taken, a time when the digital image was generated, a vehicle occupant, or an identifier of the first vehicle.

17. The computer program product of claim 16, wherein the program instructions are further executable by the processor to cause the processor to
determine a location of the first vehicle based on at least one of the digital image GPS location or the time when the digital image was generated.

18. The computer program product of claim 16, wherein, the authentication request included information regarding the first user.

19. The computer program product of claim 18, wherein the program instructions are further executable by the processor to cause the processor to:
present the first user information on the user device; and
receive an input at the first device, wherein the input is from a second user indicating the authentication request from the first user was accepted or denied based at least in part on the first user information, wherein the user device is a smart device, a cellphone, a smart watch, or a tablet computer.

20. The computer program product of claim 19, wherein the first user information further comprises an indication of whether the first user was in a state of stress when the authentication request was generated, wherein the stress indication is based on a heart rate of the first user when the authentication request was generated.
